(19) United States
(12) Patent Application Publication
(10) Pub. No.: US 2007/0296921 A1
(43) Pub. Date: Dec. 27, 2007

(54) Projection display with a cube wire-grid polarizing beam splitter

(76) Inventors: Bin Wang, Orem, UT (US); Eric Gardner, Provo, UT (US); Raymond Perkins, Orem, UT (US)

Correspondence Address: THORPE NORTH & WESTERN, LLP., 8180 SOUTH 700 EAST, SUITE 350, SANDY, UT, 84070, US

(21) Appl. No.: 11/475,857

(22) Filed: Jun. 26, 2006

(51) Int. Cl. G03B 21/14

(52) U.S. Cl. 353/20

(57) ABSTRACT

A display apparatus includes a cube wire-grid polarizing beam splitter with a plate wire-grid polarizer disposed between a pair of prisms secured together to form a cube. A reflective spatial light modulator produces an image bearing color light beam. The cube wire-grid polarizing beam splitter is disposable in the image bearing color light beam to separate the image information and to produce a polarized image bearing color light beam. A pair of continuous film layers is disposed between the plate wire-grid polarizer and a forward prism with a forward layer adjacent the forward prism having a refractive index greater than both i) a refractive index of a rear layer adjacent the plate wire grid polarizer, and ii) a refractive index of the forward prism. A layer of ribs is disposed between the wires and a rear prism, and the ribs being aligned with and supporting the wires.

### RELATED APPLICATIONS

This is related to U.S. patent application Ser. No. ______, filed Jun. 26, 2006, entitled “Cube Wire-Grid Polarizing Beam Splitter” as attorney docket no. 00546-22516; which is herein incorporated by reference.

### BACKGROUND

1. Field of the Invention

The present invention relates generally to an image projection systems incorporating a cube or prism wire-grid polarizer or polarizing beam splitter.

2. Related Art

Visible light wire-grid polarizers and wire-grid polarizing beam splitters have been developed and successfully incorporated into rear projection monitors or televisions. Such rear projection displays can use a spatial light modulator, such as a liquid crystal on silicon (LCOS) panel, to encode image information onto a polarized light beam. The wire-grid polarizer or beam splitter can be used to produce the polarized light, and/or to separate the encoded image information from the beam produced by the spatial light modulator. For example, see U.S. Pat. Nos. 6,234,634; 6,447,120. One drawback of using a wire-grid polarizing beam splitter in a rear projection display can be an increase in back focal length of the display, an increase in the thickness of the display, and/or more costly projection lenses. It is believed that the use of the wire-grid polarizing beam splitter in air causes the increase in back focal length, etc. It is an ongoing challenge to develop rear projection displays with a reduced back focal length, a reduced thickness, and/or to reduce the cost of the projection lenses.

It has been proposed to dispose a wire-grid polarizer in a cube. For example, see U.S. Pat. No. 6,288,840. It has been discovered, however, that embedding a wire-grid polarizer, such as in a prism, can detrimentally affect the performance of the wire-grid polarizer. For example, it is believed that the prism and/or interfaces with the prism alter the light, distort the polarization properties of the light, and/or decrease contrast.

### SUMMARY OF THE INVENTION

It has been recognized that it would be advantageous to develop a rear projection display system with a shorter back focal length, that is thinner, and/or that has less costly projection lenses. In addition, it has been recognized that it would be advantageous to develop a cube wire-grid polarizer or cube wire-grid polarizing beam splitter with enhanced performance or contrast. In addition, it has been recognized that it would be advantageous to develop a cube wire-grid polarizer or cube wire-grid polarizing beam splitter to facilitate assembly of image systems.

The invention provides a display apparatus with a light source to produce a light beam. At least one cube wire-grid polarizing beam splitter is disposable in the light beam to transmit a polarized light beam, and includes a plate wire-grid polarizer disposed between a pair of prisms secured together to form a cube. At least one reflective spatial light modulator is disposable in the polarized light beam to encode image information thereon to produce an image bearing light beam. The cube wire-grid polarizing beam splitter is disposable in the image bearing light beam to separate the image information and to produce a polarized image bearing light beam. Projection optics are disposable in the polarized image bearing light beam. A pair of continuous film layers is disposed between the plate wire-grid polarizer and a forward prism. A forward layer adjacent the forward prism has a refractive index greater than both i) a refractive index of a rear layer adjacent the plate wire grid polarizer, and ii) a refractive index of the forward prism. A layer of ribs is disposed between the wires and a rear prism, and the ribs are aligned with and supporting the wires.

In addition, the invention provides a modulation optical system with a reflective spatial light modulator configured to selectively encode image information on a polarized incident light beam to encode image information on a reflected beam. A cube wire-grid polarizing beam splitter is disposed immediately adjacent the reflective spatial light modulator to provide the polarized incident light beam to the reflective spatial light modulator, and to separate the image information from the reflected beam. The cube polarizing beam splitter includes a wire-grid polarizer disposed between a pair of prisms secured together to form a cube. A pair of continuous film layers is disposed between the plate wire-grid polarizer and a forward prism. A forward layer adjacent the forward prism has a refractive index greater than both i) a refractive index of a rear layer adjacent the wire-grid polarizer, and ii) a refractive index of the forward prism. A layer of ribs extends from the substrate and is aligned with and supports the array of parallel conductive wires.

In addition, the invention provides a method of shortening a back focal length of a rear-projection display apparatus, comprising:
a) obtaining a cube wire-grid polarizer with a wire-grid polarizer disposed between two prisms, a pair of continuous thin films between the wire-grid polarizer and a forward prism, with a forward film adjacent the forward prism having a refractive index greater than a refractive index of a rear film adjacent the wire-grid polarizer;
b) disposing a reflective spatial light modulator adjacent the cube wire-grid polarizer, and orienting the cube wire-grid polarizer with the pair of continuous thin films between the reflective spatial light modulator and the wire-grid polarizer;
d) disposing a recombination prism adjacent the cube wire-grid polarizer;
e) disposing projection optics adjacent the recombination prism; and
f) spacing the reflective spatial light modulator, the cube wire-grid polarizer, the recombination prism, and the projection optics closer together than without the prisms.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a side view of a cube wire-grid polarizing beam splitter in accordance with an embodiment of the present invention;

FIG. 2 is a partial cross-sectional view of the cube beam splitter of FIG. 1;

FIG. 3 is a schematic side view of an example of the cube beam splitter of FIG. 1;

FIG. 4 is a schematic side view of a plate polarizer without prisms for comparison to the cube beam splitter of FIG. 3;

FIG. 5 is a partial cross-sectional view of another cube beam splitter in accordance with an embodiment of the present invention;

FIG. 6 is a schematic side view of an example of the cube beam splitter of FIG. 5;

FIG. 7 is a schematic view of a projection display system in accordance with an embodiment of the present invention;

FIG. 8 is a schematic view of a modulation optical system in accordance with an embodiment of the present invention;

FIG. 9 is a schematic view of a projection display system in accordance with an embodiment of the present invention;

FIG. 10 is a schematic view of a projection display system in accordance with an embodiment of the present invention;

FIG. 11 is a schematic view of another projection display system in accordance with an embodiment of the present invention; and

FIG. 12 is a schematic view of another modulation optical system in accordance with an embodiment of the present invention.

Various features in the figures have been exaggerated for clarity.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Definitions

The terms polarizer and polarizing beam splitter are used interchangeably herein. Specifically, the terms wire-grid polarizer (WGP) and wire-grid polarizing beam splitter (WGP PBS) are used interchangeably herein.

The term “cube” is used broadly herein to refer to a block that can be a cube with square sides and adjacent sides at right angles; substantially a cube or cube-shaped; or other block-like shape with sides and adjacent sides at other than right angles. The term “prism” is used broadly herein to refer to a wedge that can be a wedge with parallel triangular ends with intermediate sides; substantially a prism or prism-shape; or other wedge-like shape.

Description

It has been recognized that wire-grid polarizers can provide enhanced performance or contrast to projection display systems, such as rear projection display systems. In addition, it has been recognized that it would be advantageous to reduce the back focal length of a rear projection display system, reduce the thickness of such a rear projection display system, and/or reduce the cost of projection lenses associated with the projection display system. It has been recognized that cube polarizers might be used to reduce the back focal length, and reduce the cost of the projection lenses. It is believed that the projection systems with longer back focal lengths require more costly projection lenses. It is believed that the use of wire-grid polarizing beam splitters can increase the back focal length of the projection system, requiring more expensive projection lenses. In addition, it has been recognized that the wire-grid polarizer and cube polarizer might be combined to achieve enhanced contrast, reduced back focal length, and less costly projection lenses. But it has also been recognized that the combination of the wire-grid polarizer and the cube can reduce the performance or contrast of the combination.

It is believed that the known distortion properties of the cube and wire-grid polarizer can be corrected with thin films, materials, orientation, wire-grid structure, etc., as described below. In addition, it is believed that the properties of the combination can be enhanced.

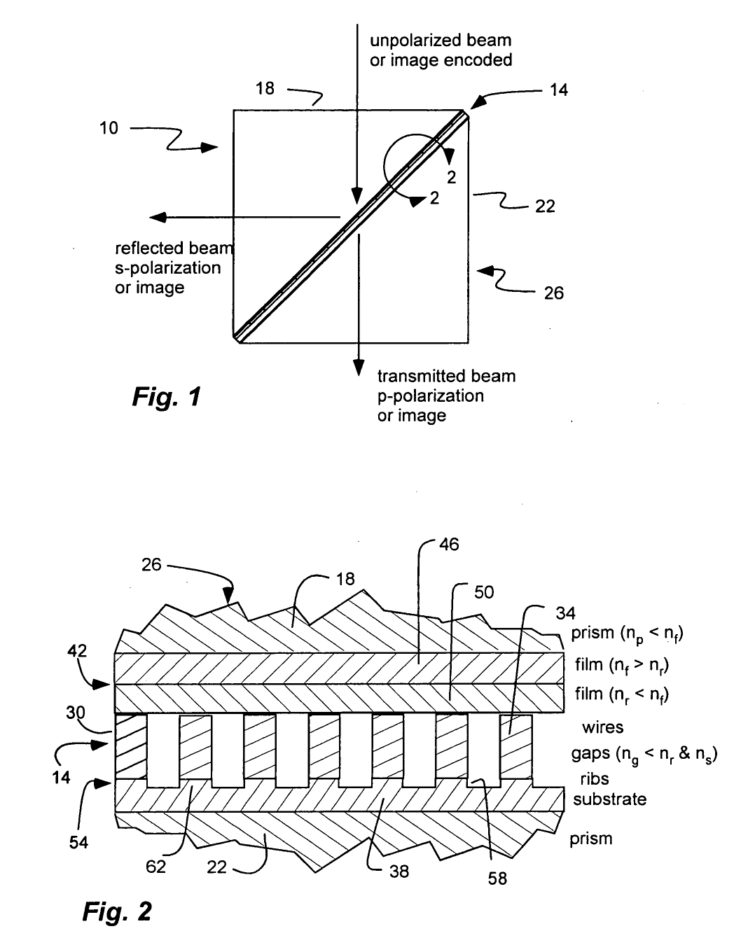

As illustrated in FIGS. 1 and 2, a cube wire-grid polarizer, or polarizing beam splitter, indicated generally at 10, is shown in an exemplary implementation in accordance with the present invention. The cube polarizer 10 includes a plate wire-grid polarizer 14 disposed or sandwiched between a pair of prisms 18 and 22 secured together to form a cube. The prisms 18 and 22 can be right triangles when viewed from the side, and can have a gap between them that is formed at a 45° angle with respect to the short sides of the triangle, and so that the long surfaces of the prisms oppose one another. One prism can be a forward prism 18 and the other can be a rear prism 22. The cube or front prism 18 can be disposed and oriented so that a light beam is incident on the forward prism. The incident light can be oriented orthogonal to the cube, and thus a 45° angle with respect to the plate polarizer or wire-grid. The incident light can be an unpolarized light beam to be polarized by the cube, or it can be an image bearing light beam with image information encoded thereon to be analyzed or separated by the cube. The plate polarizer can “face” the forward prism, as described below. Thus, the cube and/or plate polarizer can be used in a reflection mode, as described below. In addition, the cube can have an image side and can be oriented to face an LCOS, as described below. Alternatively, it will be appreciated that the cube can be oriented so that light is incident upon the rear prism, and so that the cube is used in a transmission mode.

The plate wire-grid polarizer 14 can include an array 30 of parallel conductive wires 34 disposed on or over, or carried by, a substrate 38. The wires 34 are sized and spaced to interact with the light to substantially transmit light having one polarization orientation (p-polarization), and substantially reflect light having another orthogonal polarization orientation (s-polarization). The period of the array can be less than the wavelength of visible light, or less than 0.2 μm (200 nm). The length of the wires can be longer than the wavelength of visible light, or greater than 0.7 μm (700 nm). In one aspect, the substrate can be BK7 glass (refractive index n≈1.51-1.53), and the wires can be aluminum (AL) formed on the substrate by lithographic techniques, as is known in the art. The bottom surface of the substrate (opposite the wires) can be secured to the surface of the rear prism 22, such as with a suitable adhesive selected to reduce interference with the light. Various aspects of wire-grid polarizers are described in U.S. Pat. Nos. 6,208,463; 6,081,376; 6,288,840; 6,243,199; 6,122,103; 6,785,050; 6,532,111; 6,714,350; 6,844,971; 6,665,119; and 6,788,461; which are herein incorporated by reference.

The wires 34 can define a front of the wire-grid polarizer 14 configured to face towards incident light for use in a reflection mode. While the wire-grid polarizer, and the cube, can be used in either reflection or transmission mode, i.e. with the light incident on wires or the substrate (or both), it has been found that orienting the wire-grid polarizer to face the incident light (particularly an image bearing light) in combination with the other aspects described herein produce improved results.

The cube can also have opposite layers disposed on either side of the wires, between the wires and the prisms, configured to distort the light, and thus counteract the distortion introduced by the use of the prisms and the wire-grid polarizer together.

A pair 42 of continuous film layers, such as a forward or intermediate film layer 46 and a rear film layer 50, can be disposed between the wire-grid polarizer 14 and the forward prism 18. The forward film layer 46 can be disposed adjacent or against the forward prism 18 while the rear film layer 50 can be disposed adjacent or against the wires 34. Thus, the forward or intermediate film layer 46 can be sandwiched between the forward prism 18 and the rear film layer 50. In one aspect, the pair 42 of film layers can fill the entire space between the wires 34 and the forward prism 18, so that there are only two layers. Alternatively, other film layers can be added so that there are more than two.

The forward or intermediate film layer 46 can have a refractive index (n_{f}) greater than both 1) a refractive index (nᵣ) of the rear film layer 50, and 2) a refractive index (nₚ) of the forward prism 18. (Thus, n_{f}>nᵣ, and n_{f}>nₚ.) In one aspect, the prism 18 can be BK7 glass (nₚ≈1.51-1.53). Thus, the refractive index n_{f} of the front film layer 46 can be greater than 1.53. In one aspect, the front film layer 46 can be titanium dioxide with a refractive index of approximately n_{f}≈2.3. The rear film layer 50 can be silicon dioxide with a refractive index of nᵣ of approximately 1.45.

In another aspect, the front film layer 46 can be titanium dioxide with a refractive index of approximately n_{f}≈2.25. The rear film layer 50 can be spin-on glass with a refractive index of approximately nᵣ≈1.17.

Opposite the pair 42 of film layers, another layer 54 can be disposed between the wires 34 and the opposite or rear prism 22. An array 58 of ribs 62 can extend from the substrate 38 and support the wires 34. The array 58 of ribs 62 and the array 30 of wires 34 can be aligned. An array of troughs can be interlaced between the array of ribs, and thus between the wires. The ribs 62 can be the same material as the substrate 38, and can be formed by etching the substrate between the wires. In one aspect, the ribs can be BK7 glass or a dielectric material.

### Example 1

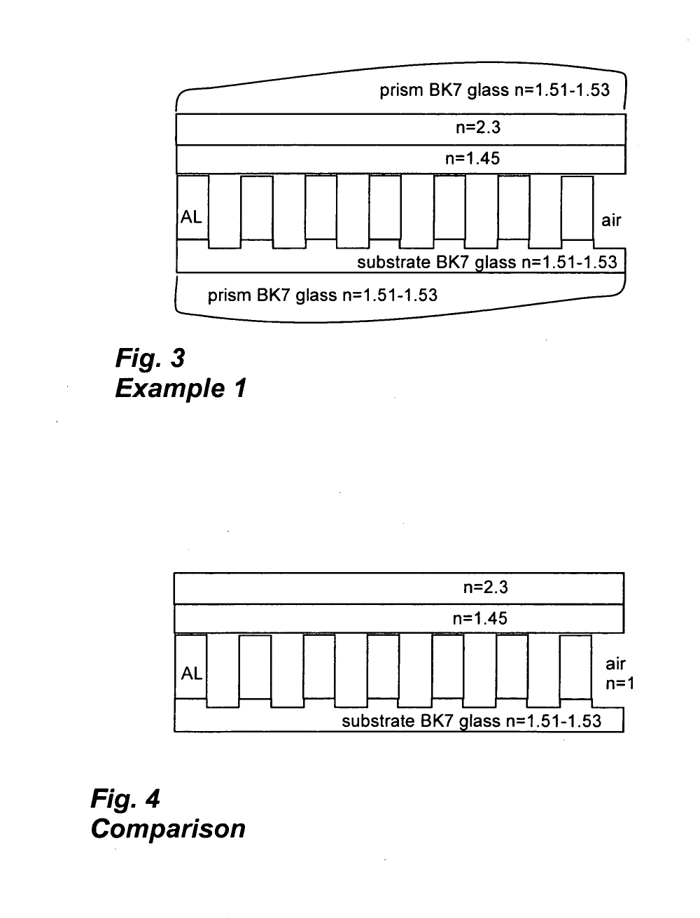

Referring to FIG. 3, a first non-limiting example of a cube wire-grid polarizer is shown. The prisms are BK7 glass (refractive index n=1.51-1.53). The substrate also is BK7 glass. The plate wire-grid polarizer includes aluminum (AL) wires and air gaps (refractive index of 1). The pitch or period of the wires is 120 nm. The rear film layer adjacent to or closer to the wires is silicon dioxide with a refractive index of n=1.45. The forward film layer adjacent to or closer to the prism is titanium dioxide with a refractive index of n=2.3.

The plate wire-grid polarizer was made by a lithography process to form the wires on the substrate. The substrate was etched between the wires to form troughs between the wires, and ribs between the troughs upon which the wires were disposed. The rear film layer was deposited over the wires, and the front film layer was deposited over the rear film layer.

By way of comparison, FIG. 4 shows a similar plate wire-grid polarizer without the cube or prisms.

The calculated performance of the cube wire-grid polarizer is shown in Table 1, compared to the plate wire-grid polarizer without the cube, and the plate wire-grid polarizer without the cube, film layers and ribs.

TABLE 1

| Wavelength (λ) | | |
|---|---|---|
| 450 nm | | |
| (blue) | 550 nm (green) | 650 nm (red) |

Example 1

| | | | |
|---|---|---|---|
| Efficiency | 84 | 85 | 86 |
| Transmission P-polarization (Tp) | 87 | 89 | 90 |
| Reflection S-polarization (Rs) | 97 | 96 | 96 |
| Transmission Contrast (Ct) | 4000 | 6000 | 8000 |
| Reflection Contrast (Cr) | 100 | 300 | 200 |

Comparison - wire-grid polarizer with film layers and ribs,
but without cube

| | | | |
|---|---|---|---|
| Efficiency | 85 | 87 | 87 |
| Transmission P-polarization (Tp) | 90 | 91 | 93 |
| Reflection S-polarization (Rs) | 94 | 94 | 93 |
| Transmission Contrast (Ct) | 400 | 600 | 1100 |
| Reflection Contrast (Cr) | 50 | 50 | 190 |

Comparison - wire-grid polarizer without cube, film layers or ribs

| | | | |
|---|---|---|---|
| Efficiency | 78 | 82 | 82 |
| Transmission P-polarization (Tp) | 85 | 89 | 90 |
| Reflection S-polarization (Rs) | 92 | 92 | 91 |
| Transmission Contrast (Ct) | 2000 | 4000 | 6400 |
| Reflection Contrast (Cr) | 25 | 150 | 1500 |

Referring to Table 1, it can be seen that the cube wire-grid polarizer has better reflection efficiency (Rs) than the plate polarizer by itself, and with only the ribs and film layers (but without the cube).

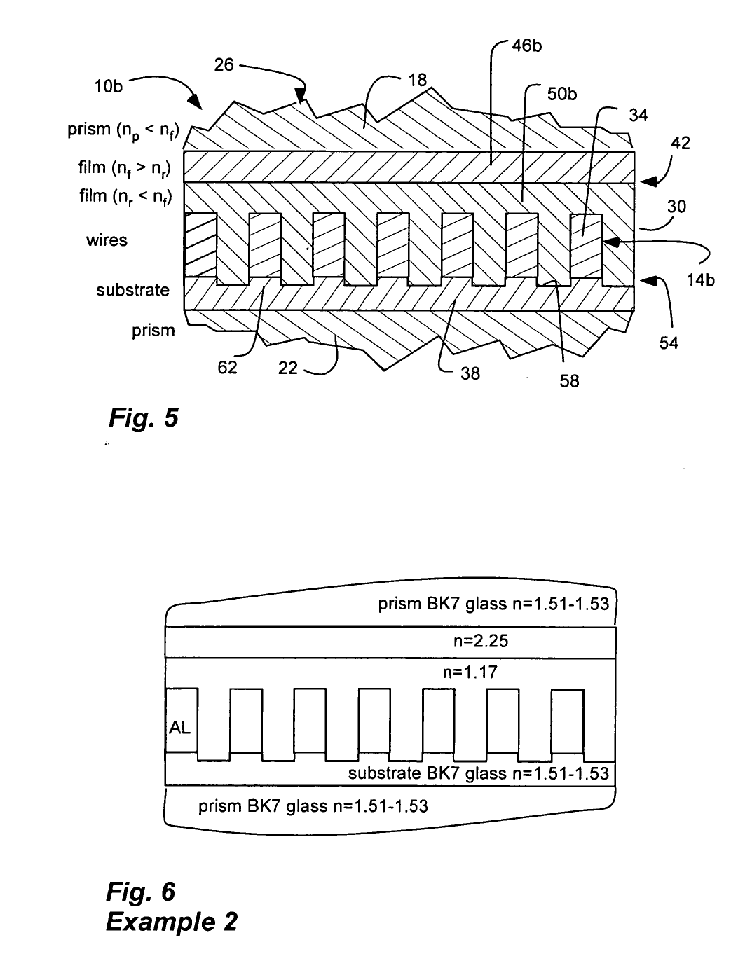

Referring to FIG. 5, another cube wire-grid polarizer, or polarizing beam splitter, indicated generally at 10b, is shown that is similar in many respects to that described above, so the above description is incorporated herein. The cube polarizer 10b or plate wire-grid polarizer 14b has gaps filled with a material, such as the same material as the rear film layer 50b. The front film layer 46b can be titanium dioxide with a refractive index of n_{f}≈2.25. The rear film layer 50b can be spin-on glass with a refractive index nᵣ of ≈1.17. Thus, the gaps can have a refractive index the same as that of the rear film layer.

### Example 2

Referring to FIG. 6, a second non-limiting example of a cube wire-grid polarizer is shown. The prisms are BK7 glass (refractive index n=1.51-1.53). The substrate also is BK7 glass. The plate wire-grid polarizer includes aluminum (AL) wires. The pitch of the wires is 120 nm. The rear film layer adjacent to or closer to the wires is spin-on glass with a refractive index of n=1.17. In addition, the material of the rear film layer fills the gaps between the wires. The front film layer adjacent to or closer to the prism is titanium dioxide with a refractive index of n=2.25.

The plate wire-grid polarizer was made by a lithography process to form the wires on the substrate. The substrate was etched between the wires to form troughs between the wires, and ribs between the troughs upon which the wires were disposed. The rear film layer was deposited over the wires, and the front film layer was deposited over the rear film layer.

The calculated performance of the cube wire-grid polarizer is shown in Table 2, compared to the cube polarizer of FIG. 3.

TABLE 2

| Wavelength (λ) | | |
|---|---|---|
| 450 nm | | |
| (blue) | 550 nm (green) | 650 nm (red) |

Example 2

| | | | |
|---|---|---|---|
| Efficiency | 87 | 89 | 89 |
| Transmission P-polarization (Tp) | 89 | 91 | 91 |
| Reflection S-polarization (Rs) | 98 | 98 | 97 |
| Transmission Contrast (Ct) | 1300 | 2200 | 2700 |
| Reflection Contrast (Cr) | 200 | 700 | 600 |

Comparison with Example 1

| | | | |
|---|---|---|---|
| Efficiency | 84 | 85 | 86 |
| Transmission P-polarization (Tp) | 87 | 89 | 90 |
| Reflection S-polarization (Rs) | 97 | 96 | 96 |
| Transmission Contrast (Ct) | 4000 | 6000 | 8000 |
| Reflection Contrast (Cr) | 100 | 300 | 200 |

Referring to Table 2, it can be seen that the cube wire-grid polarizer with filled gaps may have better overall efficiency, better reflection efficiency (Rs) and better reflection contrast (Cr) than the cube wire-grid polarizer with the air gaps, based on the exemplary configurations shown.

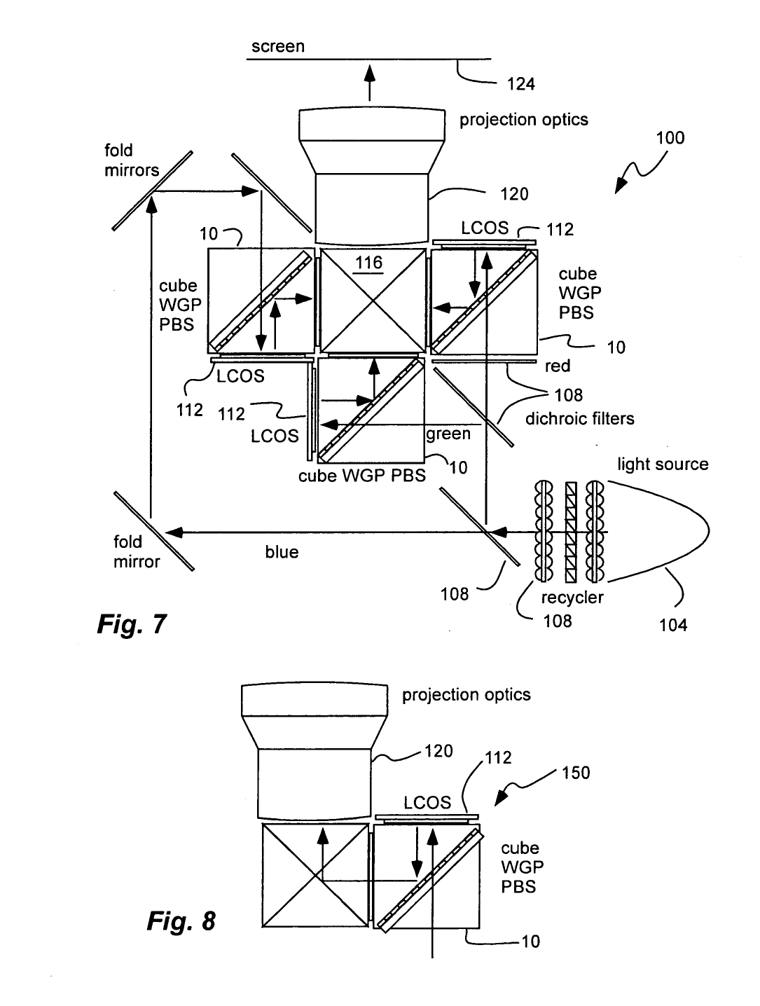

Referring to FIG. 7, a projection display system 100 is shown in accordance with the present invention. The system 100 includes a light source 104 to produce a light beam. The beam can be treated by various optics, including beam shaping optics, recycling optics, polarizing optics, etc. (Various aspects of using a wire-grid polarizer in light recycling are shown in U.S. Pat. Nos. 6,108,131 and 6,208,463; which are herein incorporated by reference.) One or more color separator(s) 108, such as dichroic filters, can be disposable in the light beam to separate the light beam into color light beams, such as red, green and blue. At least one cube wire-grid polarizing beam splitter 10 can be disposable in one of the color light beams to transmit a polarized color light beam. As described above, the cube beam splitter 10 can include a plate wire-grid polarizer disposed between a pair of prisms secured together to form a cube. At least one reflective spatial light modulator 112, such as an LCOS panel, can be disposable in the polarized color light beam to encode image information thereon to produce an image bearing color light beam. The cube wire-grid polarizing beam splitter 10 can be disposable in the image bearing color light beam to separate the image information and to reflect a polarized image bearing color light beam. As shown, three cube polarizers 10 and three spatial light modulators 112 can be used, one for each color of light (blue, green, red). The polarized image bearing color light beams can be combined with an X-cube or recombination prism 116. Projection optics 120 can be disposable in the polarized image bearing color light beam to project the image on a screen 124.

As described above, the cube polarizer 10 can have a pair of continuous film layers disposed between the plate wire-grid polarizer and one of the pair of prisms with a layer adjacent the prism having a refractive index greater than both i) a refractive index of a layer adjacent the plate wire grid polarizer, and ii) a refractive index of an adjacent prism; and a layer of ribs extending from the substrate and aligned with and supporting the array of parallel conductive wires.

The cube polarizer 10 can face, or can have an image side that faces, the spatial light modulator 112. The facing or image side is opposite the substrate on which the wire-grid is disposed, or is the side with the film layers.

As described above, it is desirable to reduce the thickness of the projection display, reduce the back focal length of the projection display, and/or reduce the cost of the projection optics. The back focal length is the optical path distance between the spatial light modulator, or LCOS panel, and the projection lens. It is difficult to arbitrarily shortened this distance in an actual projection system because the spatial light modulator and other components must all fit within the physical space allowed by the desired back focal length. However, the optical path distance can be decoupled from the physical distance by the use of materials with a higher optical index. Therefore, using the cube polarizer described above allows the back focal length to be shortened for a given physical space required in order to fit the required components together. This is accomplished while also compensating for, or improving, the performance of the cube polarizer due to the prisms on both sides of the wire-grid.

The spatial light modulator 112, or LCOS, can disposed immediately adjacent the cube wire-grid polarizing beam splitter 10, thus reducing the back focal length. One or more polarization compensators may be disposed between the LCOS and the cube. In addition, a combining prism 116, or x-cube, can be disposed between the cube wire-grid polarizing beam splitter 10 and the projection optics 120. The combining prism 116 can be disposed adjacent the cube polarizer 10, but a clean-up or post polarizer can be disposed therebetween. In one aspect, the cube polarizer 10 used in the projection display 100 can result in a back focal length less than approximately 3 inches defined by a distance between the spatial light modulator and the projection optics that is less than approximately 3 inches. In another aspect, the back focal length can be less than approximately 2 inches.

Alternatively, the light source can include an LED array. The LED array can be disposed adjacent the cube wire-grid polarizing beam splitter opposite the spatial light modulator or LCOS. The LED array can include groupings of individual colored LEDs, such as red, green and blue. The LED array or colored LEDs can be modulated to produce colored light. For example, the LED array can provide sequential pulses of colored light. Similarly, the spatial light modulator can be modulated along with the LED array to correspond to the pulses of colored light. Thus, the light and image can be provided on a single channel, with a single light source, a single spatial light modulator, and a single cube beam splitter.

Referring to FIG. 8, it will be appreciated that the cube polarizer 10 described above can be used in a subsystem of the projection display, such as a light engine or a modulation optical system 150, which includes the spatial light modulator 112 and cube polarizer 10. Such a modulation optical system may also include a light source, color separators, beam shaping optics, light recycler, pre-polarizers, post-polarizers, compensators, and/or an x-cube. One or more modulation optical systems can be combined with other optics and components in a projection system.

As described above, the reflective spatial light modulator 112 can be configured to selectively encode image information on a polarized incident light beam to encode image information on a reflected beam. The cube wire-grid polarizing beam splitter 10 can be disposed immediately adjacent the reflective spatial light modulator to provide the polarized incident light beam to the reflective spatial light modulator, and to separate the image information from the reflected beam. The cube polarizer can include a plate wire-grid polarizer disposed between a pair of prisms secured together to form a cube. A pair of continuous film layers can be disposed between the plate wire-grid polarizer and one of the pair of prisms with a layer adjacent the prism having a refractive index greater than both i) a refractive index of a layer adjacent the plate wire-grid polarizer, and ii) a refractive index of an adjacent prism. A layer of ribs can extend from the substrate and can be aligned with and support the array of parallel conductive wires.

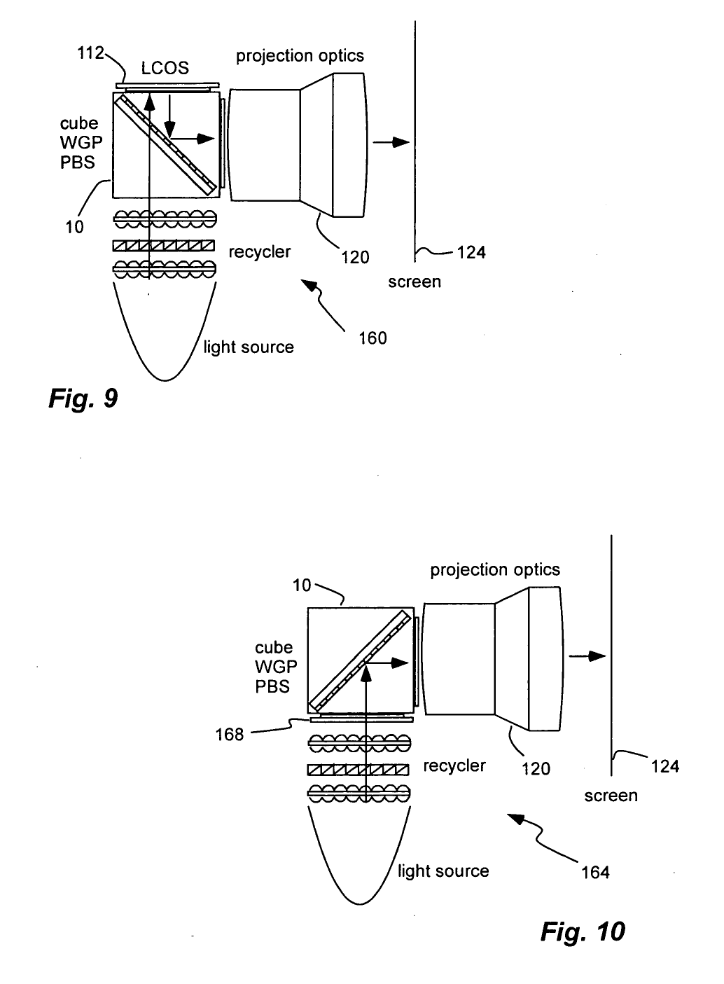

Although a three channel, or three color, projection system has been described above, it will be appreciated that a display system 160 or 164 can have a single channel, as shown in FIGS. 9 and 10. In addition, although the cube beam splitter has been described above as being used with a reflective spatial light modulator, such as an LCOS panel, it will be appreciated that the cube beam splitter can be used with a transmissive spatial light modulator 168, as shown in FIG. 10. In the configuration shown in FIG. 10, the cube may not need the rear prism.

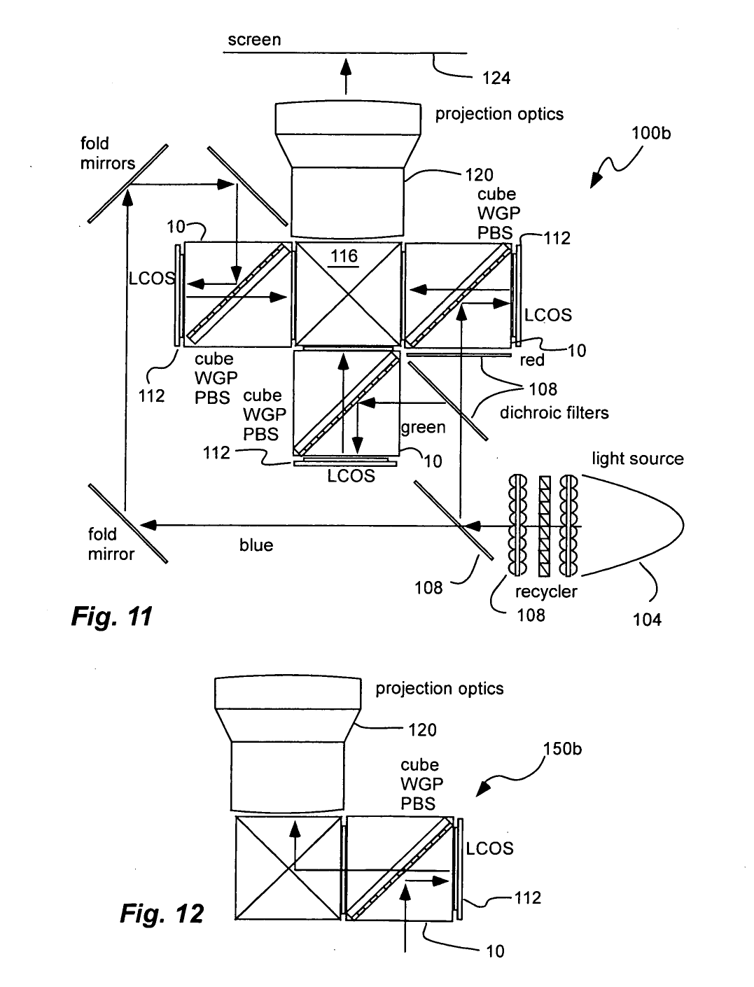

Although a projection system and modulation optical system were shown in FIGS. 7 and 8 with the cube polarizer in reflection mode, it will be appreciated that a projection system 100b or modulation optical system 150b can be configured with the cube polarizer in transmission mode, as shown in FIGS. 11 and 12.

A method of shortening a back focal length of a rear-projection display apparatus includes (without regard to order) 1) obtaining a cube wire-grid polarizer with a wire-grid polarizer disposed between two prisms, a pair of continuous thin films between the wire-grid polarizer and a forward prism, with a forward film adjacent the forward prism having a refractive index greater than a refractive index of a rear film adjacent the wire-grid polarizer; 2) disposing a reflective spatial light modulator adjacent the cube wire-grid polarizer, and orienting the cube wire-grid polarizer with the pair of continuous thin films between the reflective spatial light modulator and the wire-grid polarizer; 3) disposing a recombination prism adjacent the cube wire-grid polarizer; 4) disposing projection optics adjacent the recombination prism; and 5) spacing the reflective spatial light modulator, the cube wire-grid polarizer, the recombination prism, and the projection optics closer together than without the prisms.

A method of making a cube wire-grid polarizer device includes (without regard to order) 1) forming an array of parallel conductive wires on a substrate, the wires having a size and a period to interact with light to substantially transmit light having one polarization orientation and substantially reflect light having another polarization orientation; 2) etching into the substrate between the wires to form an array of troughs with an interlaced array of ribs upon which the wires are disposed; 3) disposing a first continuous film layer in front of the array of wires; 4) disposing a second continuous film layer in front of the first layer, the second layer having a refractive index greater than a refractive index of the first layer; 5) securing the substrate to a first prism; and 6) securing a second prism to the first to form a cube with the substrate between the first and second prisms.

Disposing the first continuous film layer can include depositing a material onto the wires. The second layer can be disposed over the first. Alternatively, disposing the second continuous film layer can include deposition a material onto the second prism.

The substrate can be secured to the prism by a suitable adhesive. Similarly, the second layer can be secured to the other prism with a suitable adhesive. Alternatively, the prisms, plate polarizer and layers can be secured together without adhesive, such as being mechanically held in place, such as with a fixture or clip.

Various aspects of projection display systems with wire-grid polarizers or wire-grid polarizing beam splitters are shown in U.S. Pat. Nos. 6,234,634; 6,447,120; 6,666,556; 6,585,378; 6,909,473; 6,900,866; 6,982,733; 6,954,245; 6,897,926; 6,805,445; 6,769,779 and U.S. patent application Ser. Nos. 10/812,790; 11/048,675; 11/198,916; 10/902,319; which are herein incorporated by reference.

Although a rear projection system has been described herein it will be appreciated that a projection system can be of any type, including a front projection system.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A display apparatus, comprising:
a) a light source to produce a light beam;
b) at least one cube wire-grid polarizing beam splitter disposable in the light beam to transmit a polarized light beam, and including a plate wire-grid polarizer disposed between a pair of prisms secured together to form a cube;
c) at least one reflective spatial light modulator disposable in the polarized light beam to encode image information thereon to produce an image bearing light beam;
d) the cube wire-grid polarizing beam splitter being disposable in the image bearing light beam to separate the image information and to produce a polarized image bearing light beam;
e) projection optics disposable in the polarized image bearing light beam;
f) a pair of continuous film layers disposed between the plate wire-grid polarizer and a forward prism with a forward layer adjacent the forward prism having a refractive index greater than both i) a refractive index of a rear layer adjacent the plate wire grid polarizer, and ii) a refractive index of the forward prism; and
g) a layer of ribs disposed between the wires and a rear prism, and the ribs being aligned with and supporting the wires.

2. An apparatus in accordance with claim 1, wherein the spatial light modulator is disposed immediately adjacent the cube wire-grid polarizing beam splitter.

3. An apparatus in accordance with claim 1, further comprising a combining prism disposed between the cube wire-grid polarizing beam splitter and the projection optics.

4. An apparatus in accordance with claim 1, wherein an optical distance between the spatial light modulator and the projection optics is less than approximately 3 inches.

5. An apparatus in accordance with claim 1, wherein the cube wire-grid polarizing beam splitter is oriented to face the spatial light modulator.

6. An apparatus in accordance with claim 1, wherein the cube wire-grid polarizing beam splitter and the spatial light modulator are oriented and configured to reflect the polarized image bearing color light beam from the beam splitter.

7. An apparatus in accordance with claim 1, wherein the cube wire-grid polarizing beam splitter and the spatial light modulator are oriented and configured to transmit the polarized image bearing color light beam through the beam splitter.

8. An apparatus in accordance with claim 1, wherein the light source includes an LED array.

9. An apparatus in accordance with claim 1, further comprising:
a) beam shaping optics disposable in the light beam;
b) at least one color separator disposable in the light beam to separate the light beam into color light beams;
c) the at least one cube wire-grid polarizing beam splitter being disposable in one of the color light beams to transmit a polarized color light beam;
d) the at least one reflective spatial light modulator being disposable in the polarized color light beam to encode image information thereon to produce an image bearing color light beam;
e) the cube wire-grid polarizing beam splitter being disposable in the image bearing color light beam to separate the image information and to produce a polarized image bearing color light beam;
f) the projection optics being disposable in the polarized image bearing color light beam; and
g) a combining prism disposed between the cube wire-grid polarizing beam splitter and the projection optics.

10. A modulation optical system, comprising:
a) a reflective spatial light modulator configured to selectively encode image information on a polarized incident light beam to encode image information on a reflected beam;
b) a cube wire-grid polarizing beam splitter disposed adjacent the reflective spatial light modulator to provide the polarized incident light beam to the reflective spatial light modulator, and to separate the image information from the reflected beam to produce a polarized image bearing light beam, and including a plate wire-grid polarizer disposed between a pair of prisms secured together to form a cube;
c) a pair of continuous film layers disposed between the plate wire-grid polarizer and a forward prism with a forward layer adjacent the forward prism having a refractive index greater than both i) a refractive index of a rear layer adjacent the wires, and ii) a refractive index of the forward prism; and
d) a layer of ribs disposed between the wires and a rear prism, the ribs being aligned with and supporting the wires.

11. A system in accordance with claim 10, further comprising:
a) a light source to produce a light beam;
b) beam shaping optics disposable in the light beam;
c) at least one color separator disposable in the light beam to separate the light beam into color light beams; and
d) projection optics disposable in the polarized image bearing light beam.

12. A system in accordance with claim 11, further comprising a combining prism disposed between the cube wire-grid polarizing beam splitter and the projection optics.

13. A system in accordance with claim 11, wherein an optical distance between the spatial light modulator and the projection optics is less than approximately 3 inches.

14. A system in accordance with claim 10, wherein the cube wire-grid polarizing beam splitter is oriented to face the spatial light modulator.

15. A system in accordance with claim 10, wherein the cube wire-grid polarizing beam splitter and the spatial light modulator are oriented and configured to reflect the polarized image bearing color light beam from the beam splitter.

16. A system in accordance with claim 10, wherein the cube wire-grid polarizing beam splitter and the spatial light modulator are oriented and configured to transmit the polarized image bearing color light beam through the beam splitter.

17. A method of shortening a back focal length of a rear-projection display apparatus, comprising:
a) obtaining a cube wire-grid polarizer with a wire-grid polarizer disposed between two prisms, a pair of continuous thin films between the wire-grid polarizer and a forward prism, with a forward film adjacent the forward prism having a refractive index greater than a refractive index of a rear film adjacent the wire-grid polarizer;
b) disposing a reflective spatial light modulator adjacent the cube wire-grid polarizer, and orienting the cube wire-grid polarizer with the pair of continuous thin films between the reflective spatial light modulator and the wire-grid polarizer;
d) disposing a recombination prism adjacent the cube wire-grid polarizer;
e) disposing projection optics adjacent the recombination prism; and
f) spacing the reflective spatial light modulator, the cube wire-grid polarizer, the recombination prism, and the projection optics closer together than without the prisms.

18. A method in accordance with claim 17, wherein a distance between the spatial light modulator and the projection optics is less than approximately 3 inches.

19. A modulation optical system, comprising:
a) a spatial light modulator configured to selectively encode image information on a polarized incident light beam to encode image information on a beam;
b) a cube wire-grid polarizing beam splitter disposed adjacent the reflective spatial light modulator to separate the image information from the beam, and including a plate wire-grid polarizer disposed between a pair of prisms secured together to form a cube;
c) a pair of continuous film layers disposed between the plate wire-grid polarizer and a forward prism with a forward layer adjacent the forward prism having a refractive index greater than both i) a refractive index of a rear layer adjacent the wires, and ii) a refractive index of the forward prism; and
d) a layer of ribs disposed between the wires and a rear prism, the ribs being aligned with and supporting the wires.
